(19) United States
(12) Patent Application Publication
(10) Pub. No.: US 2010/0297569 A1
(43) Pub. Date: Nov. 25, 2010

(54) Dental Brace with Brackets Having a Latch Type Sliding Cover for Positioning Arch Wire

(76) Inventors: Ching-Hui Huang, Taichung City (TW); Cheng-Yi Lin, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/470,546

(22) Filed: May 22, 2009

(51) Int. Cl. A61C 7/12

(52) U.S. Cl. 433/10

(57) ABSTRACT

A dental brace includes a plurality of pairs of bracket and sliding cover. The bracket includes an attaching base attached to a tooth, a support extending upward obliquely from the attaching base, a top jaw, a transverse groove in the support, two side inclined grooved rails on the support, and a projecting abutment member. On a recessed, inclined surface of the support there are provided a transverse ridge and a shoulder below the ridge. The sliding cover comprises a latch extending downward from an upper end. The groove is open when the latch is stopped by the shoulder so as to permit an arch wire to dispose in the grooves. The groove is concealed by the sliding cover when the latch is urged against an inclined surface of the ridge so as to position the arch wire in the grooves.

### BACKGROUND OF THE INVENTION

1. Field of Invention

The invention relates to orthodontic appliances and more particularly to a dental brace including a plurality of brackets each having a latch type sliding cover for positioning an arch wire passing a groove of the bracket.

2. Description of Related Art

A conventional dental brace is shown in FIG. 6 and comprises a plurality of brackets 60 attached to outer surfaces of teeth 70, and an arch wire (not numbered) being positioned around the brackets 60. One drawback of the conventional dental brace is that the brackets 60 are relatively thick. Hence, the lip may feel a degree of discomfort when contacting the dental brace. The mounting of the brackets 60 on inner surfaces of teeth 70 improves nothing since the tongue may feel a degree of discomfort when licking the dental brace.

Further, as shown in FIG. 7, a sliding cover 81 of one of a plurality of brackets 80 of another conventional dental brace can be removing by precisely pressing the sliding cover 81 by means of an auxiliary tool 90 and then pulling downward. However, it has the drawbacks of the above discomfort and is inconvenient in use. Thus, the need for improvement still exists.

### SUMMARY OF THE INVENTION

It is therefore one object of the invention to provide a dental brace comprising an arch wire; a plurality of brackets each comprising an attaching base adapted to attach to a tooth by adhering, a support extending upward obliquely from the attaching base, a jaw at a top of the support, a transverse groove in the support below the jaw, two inclined grooved rails on both sides of a recessed, inclined surface of the support, and an abutment member projecting out of the upper jaw opposing the grooved rails wherein the support comprises a ridge formed transversely between the grooved rails on its recessed, inclined surface, and a shoulder formed transversely between the grooved rails and disposed below the ridge; and a plurality of sliding covers each cooperating with the bracket and comprising an uneven main section slidably secured to the grooved rails, and a latch extending downward from the upper end of the main section and being at an acute angle with respect thereto, wherein the groove is open when the latch is stopped by the shoulder so as to permit the arch wire to dispose in the grooves; and wherein the groove is concealed by the sliding cover when the latch is urged against an inclined surface of the ridge so as to position the arch wire in the grooves.

In a first aspect of the invention the abutment member comprises an elastic wire, the elastic wire is adapted to tie around the abutment members.

In a second aspect of the invention the abutment member is shaped as a T.

In a third aspect of the invention the latch is flexible.

In a fourth aspect of the invention the main section comprises a top cavity between upper and lower ends, and a V-shaped raised edge extending toward both sides thereof from the cavity for facilitating a pointed auxiliary tool to position at the cavity.

In a fifth aspect of the invention the main section further comprises an arc flange on an upper edge of the cavity opposite the V-shaped raised edge so as to form a gap between the flange and either section of the V-shaped raised edge.

In a sixth aspect of the invention the main section further comprises a concave edge on the lower end.

By utilizing the invention, advantages including easy removal or installation of the arch wire, and users having a feeling of comfort when wearing the dental brace, easy attachment to either outer surfaces or inner surfaces of teeth, and being more aesthetic if it is attached to inner surfaces of teeth can be obtained.

The above and other objects, features and advantages of the invention will become apparent from the following detailed description taken with the accompanying drawings.

### BRIEF DESCRIPTION OF THE DRAWINGS

FIG. 1 is an exploded perspective view of a preferred embodiment of bracket of dental brace according to the invention;

FIG. 2 is a longitudinal sectional view of the assembled bracket;

FIG. 3 is a side elevation of the bracket shown in FIG. 2;

FIG. 4 is a perspective view of a dental brace incorporating the brackets of the invention attaching to outer surfaces of the teeth in one configuration;

FIG. 5 is a view similar to FIG. 4 showing the brackets of the invention attaching to inner surfaces of the teeth in the other configuration;

FIG. 6 is a perspective view of a conventional dental brace with brackets having a sliding cover for positioning an arch wire; and

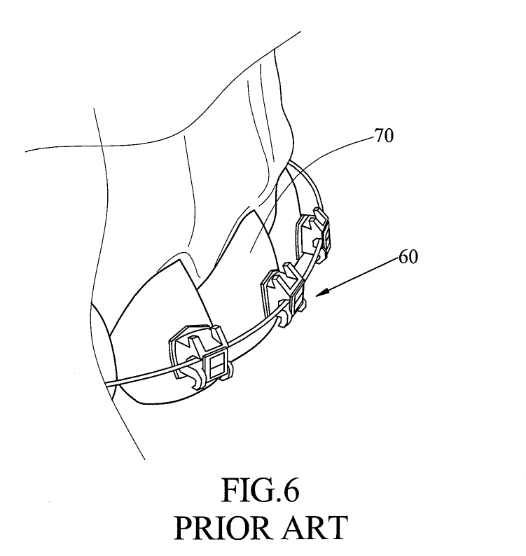

FIG. 7 is a perspective view of a bracket of another conventional dental brace showing an operation of removing a sliding cover by means of an auxiliary tool.

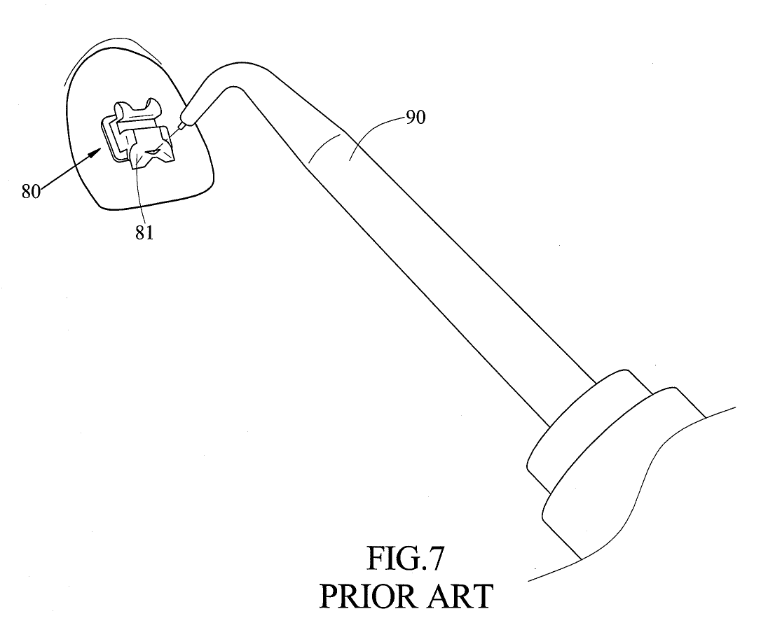

### DETAILED DESCRIPTION OF THE INVENTION

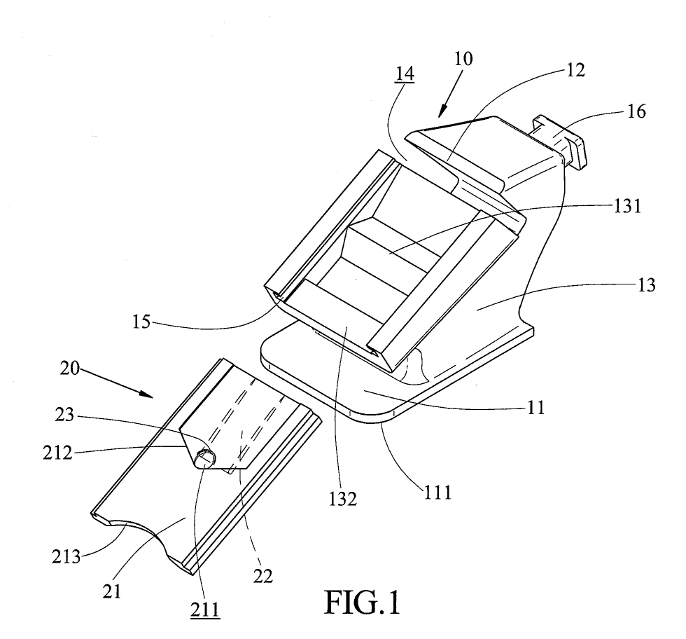

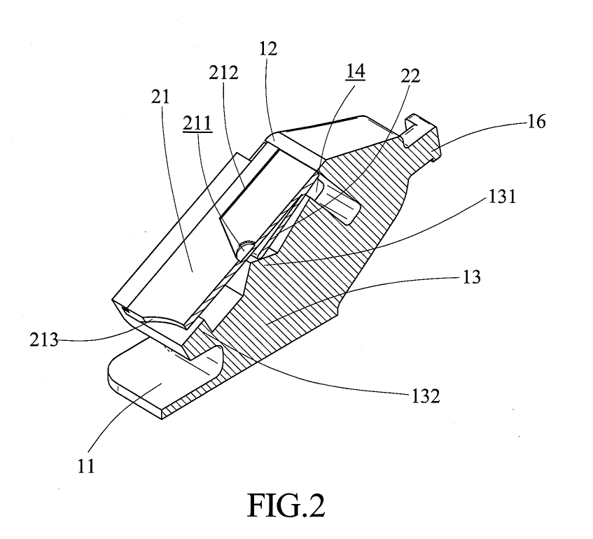

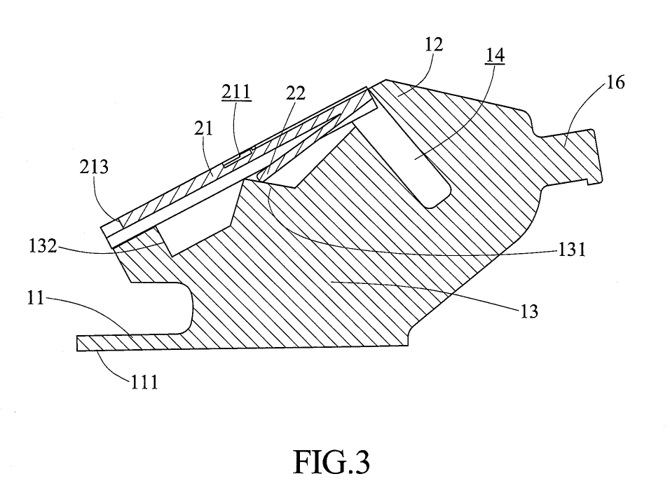

Referring to FIGS. 1 to 4, a dental brace in accordance with a preferred embodiment of the invention comprises a plurality of brackets 10 each being equipped with a sliding cover 20. Each of above components will now be described in detail below.

The bracket 10 comprises a rectangular attaching base 11, an inclined support 13 extending upward from the attaching base 11, a fixed upper jaw 12, a transverse groove 14 in the inclined support 13 below the upper jaw 12, two inclined grooved rails 15 on both sides of an inclined surface of the inclined support 13, and an abutment member 16 projecting out of the upper jaw 12 opposing the grooved rails 15.

The attaching base 11 has an attaching surface 111 for attaching to a tooth by adhering. On a recessed portion of the inclined surface of the inclined support 13 a ridge 131 is formed transversely between intermediate portions of the grooved rails 15, and a shoulder 132 is formed transversely between the intermediate portions of the grooved rails 15 and is disposed below the ridge 131.

The sliding cover 20 is rectangular and comprises an uneven main section 21 and a flexible latch 22 extending from an upper end of an underside of the main section 21. The latch 22 is at an acute angle with respect to the main section 21. Both sides of the main section 21 are slidably secured to the grooved rails 15. The groove 14 is open when the latch 22 is stopped by the shoulder 132. Hence, an arch wire 40 may loop around the grooves 14 of the brackets 10 for mounting. To the contrary, the groove 14 is concealed by the sliding cover 20 when the latch 22 is urged against an inclined surface of the ridge 131. As a result, the arch wire 40 is positioned in the groove 14.

The abutment member 16 comprises an elastic wire (not shown) or an elastic element (not shown). The elastic wire may tie around the abutment members 16 to compress and fasten same so that the arch wire 40 can be held in place. This has the effect of helping the dental brace correct irregularities in the position of the teeth 30.

The abutment member 16 is shaped as a T so as to facilitate the elastic wire to loop around the abutment members 16.

Preferably, the latch 22 is a flexible plate.

The main section 21 of the sliding cover 20 comprises a central, circular cavity 211 on a top, a recess (not numbered) extending from an upper end to about the cavity 211, and a V-shaped raised edge 212 on a lower end of the recess adjacent the cavity 211. The provision of the V-shaped raised edge 212 can facilitate a pointed auxiliary tool (not shown) to position at the cavity 211.

On the recess of the main section 21 of the sliding cover 20 there is further provided an arc flange 23 on an upper edge of the cavity 211 opposite the V-shaped raised edge 212, resulting in the forming of a gap (not numbered) between the flange 23 and either section of the V-shaped raised edge 212. Thus, a pointed end of the auxiliary tool contacting the cavity 211 may be held in place by the flange 23 so that an opening or closing operation of the sliding cover 20 can be made easy by sliding the sliding cover 20 along the grooved rails 15.

In addition to the latch 22 extending from an upper end of an underside of the main section 21, a lower end of the main section 21 of the sliding cover 20 is formed with a concave edge 213 which can facilitate the sliding operation of the sliding cover 20 by means of the auxiliary tool.

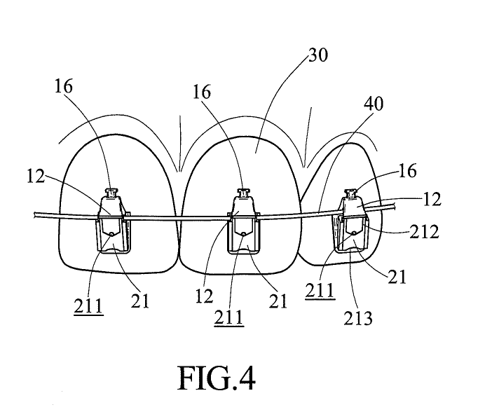

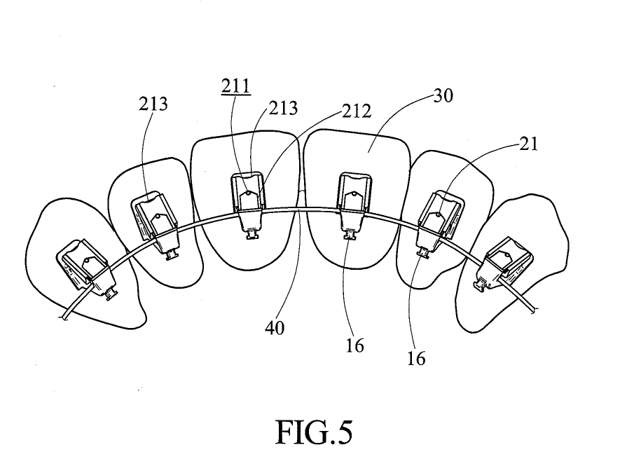

Referring to FIG. 5 in conjunction with FIGS. 1 and 4, the installation of the brackets of the dental brace is shown. In FIG. 4, the brackets of the dental brace are attached to outer surfaces of teeth 30. In FIG. 5, the brackets of the dental brace are attached to inner surfaces of teeth 30. In the latter case, the dental brace is hidden by the teeth 30. Hence, it is more aesthetic. Advantageously, either configuration of the dental brace can obtain the purpose of correcting irregularities in the position of the teeth 30.

While the invention herein disclosed has been described by means of specific embodiments, numerous modifications and variations could be made thereto by those skilled in the art without departing from the scope and spirit of the invention set forth in the claims.

What is claimed is:

1. A dental brace comprising:
an arch wire (40);
a plurality of brackets (10) each comprising an attaching base (11) adapted to attach to a tooth by adhering, a support (13) extending upward obliquely from the attaching base (11), a jaw (12) at a top of the support (13), a transverse groove (14) in the support (13) below the jaw (12), two inclined grooved rails (15) on both sides of a recessed, inclined surface of the support (13), and an abutment member (16) projecting out of the upper jaw (12) opposing the grooved rails (15) wherein the support (13) comprises a ridge (131) formed transversely between the grooved rails (15) on its recessed, inclined surface, and a shoulder (132) formed transversely between the grooved rails (15) and disposed below the ridge (131); and
a plurality of sliding covers (20) each cooperating with the bracket (10) and comprising an uneven main section (21) slidably secured to the grooved rails (15), the main section (21) including a top cavity (211) between upper and lower ends, and a V-shaped raised edge (212) extending toward both sides thereof from the cavity (211); and a flexible latch (22) extending downward from the upper end of the main section (21) and being at an acute angle with respect thereto,
wherein the groove (14) is open when the latch (22) is stopped by the shoulder (132) so as to permit the arch wire (40) to dispose in the grooves (14); and
wherein the groove (14) is concealed by the sliding cover (20) when the latch (22) is urged against an inclined surface of the ridge (131) so as to position the arch wire (40) in the grooves (14).

2. The dental brace of claim 1, wherein the abutment member (16) is shaped as a T.

3. The dental brace of claim 1, wherein the main section (21) further comprises an arc flange (23) on an upper edge of the cavity (211) opposite the V-shaped raised edge (212) so as to form a gap between the flange (23) and either section of the V-shaped raised edge (212).

4. The dental brace of claim 1, wherein the main section (21) further comprises a concave edge (213) on the lower end.
